(19) United States
(12) Patent Application Publication
(10) Pub. No.: US 2014/0340412 A1
(43) Pub. Date: Nov. 20, 2014

(54) HARDWARE UNIT FOR FAST SAH-OPTIMIZED BVH CONSTRUTION

(71) Applicant: The Provost, Fellows, Foundation Scholars, & the other members of Board, et al., Dublin (IE)

(72) Inventors: Michael John Doyle, Dublin (IE); Colin Fowler, Co. Carlow (IE); Michael Manzke, Dublin (IE)

(21) Appl. No.: 14/277,386

(22) Filed: May 14, 2014

Related U.S. Application Data
(60) Provisional application No. 61/823,337, filed on May 14, 2013.

(51) Int. Cl. G06T 1/20

(52) U.S. Cl. CPC G06T 1/20; G06T 2210/52
USPC 345/522

(57) ABSTRACT

A graphics data processing architecture is disclosed for constructing a hierarchically-ordered acceleration data structure in a rendering process. The architecture includes at least first and second builder modules, connected to one another and respectively configured for building a plurality of upper and lower hierarchical levels of the data structure. Each builder module comprises at least one memory interface with at least a pair of memories; at least two partitioning units, each connected to one respective of the pairs of memories; at least three binning units connected with each partitioning unit and the memory interface, one binning unit for each of the threes axes X, Y and Z of a three-dimensional graphics scene; and a plurality of calculating modules connected with the binning units for calculating a computing cost associated with each of a plurality of splits from a splitting plane and for outputting data representative of a lowest cost split.

### CROSS-REFERENCE TO RELATED APPLICATION

This application claims priority to U.S. Provisional Application No. 61/823,337 filed May 14, 2013, the contents of which are herein incorporated by reference.

### FIELD

The present invention relates to a computing architecture for processing graphics data. The present invention relates to a graphics data processing architecture for constructing bounding volume hierarchies in a rendering process.

### BACKGROUND

In the field of computer graphics, ray tracing algorithms are known for producing highly realistic images, but at a significant computational cost. For this reason, a large body of research exists on various techniques for accelerating these costly algorithms, on both central processing unit (CPU) and graphics processing unit (GPU) platforms.

Perhaps the most effective acceleration method known for ray-tracing is the use of acceleration data-structures. Among the most widely used acceleration data-structures are bounding volume hierarchies (BVHs) and kd-trees. These structures provide a spatial map of the scene that can be used for quickly culling away superfluous intersection tests. The efficacy of such structures in improving performance has made them an essential ingredient of any interactive ray-tracing system. When rendering dynamic scenes, these structures must be rebuilt or updated over time, as the spatial map provided by the structure is invalidated by scene motion. For dynamic scenes, the proportion of time spent building these data-structures represents a considerable portion of the total time to image. A great deal of research has therefore been directed to the goal of faster construction of these essential structures.

The bounding volume hierarchy (BVH) is one of the most widely used acceleration data-structures in ray-tracing. This can be attributed to the fact that it has proven to represent a good compromise between traversal performance and construction time. In addition, fast refitting techniques are available for BVHs [Lauterbach et al. 2006; Kopta et al. 2012], making them highly suitable for deformable geometry.

The classical BVH is typically a binary tree in which each node of the tree represents a bounding volume (typically an axis-aligned bounding box (AABB)) which bounds some subset of the scene geometry. The AABB corresponding to the root node of the tree bounds the entire scene. The two child nodes of the root node bound disjoint subsets of the scene, and each scene primitive will be present in exactly one of the children. The two child nodes can be recursively subdivided in a similar fashion until a termination criterion is met. Typical strategies include terminating at a certain number of primitives, or at a maximum tree depth.

For ray-tracing, many BVH construction algorithms follow a top-down procedure. Starting with the root node, nodes are split according to a given splitting strategy and child nodes produced which are further subdivided until a leaf node is reached. The choice of how to split the nodes can have a profound effect on rendering efficiency. Perhaps the most widely used strategy is the surface area heuristic (SAH). The SAH estimates the expected ray traversal cost C for a given split, and can be written as:

$$C ( V -> ( L , R ) ) = {K}_{T} + {K}_{I} ( \frac{SA ( {V}_{L} )}{SA ( V )} {N}_{L} + \frac{SA ( {V}_{R} )}{SA ( V )} {N}_{R} )$$

wherein V is the original volume, V_{L} and V_{R} are the subvolumes of the left and right child nodes, N_{L} and N_{R} are the number of primitives in the left and right child nodes, and SA is the surface area. K_{I} and K_{T} are implementation-specific constants representing the cost of ray/primitive intersection and traversal respectively.

The SAH can be evaluated for a number of split candidates and the best candidate chosen. Sweep builds sort all primitives along a given axis and evaluate each possible sorted primitive partitioning, which yields highly efficient trees, but at a construction cost too high for real-time performance. Binned SAH algorithms approximate this process by evaluating the SAH at a small number of locations (typically 16 or 32) spread evenly over the candidate range. The binned SAH algorithm achieves much faster build times, while preserving high rendering efficiency, and is therefore more suitable for real-time application.

The construction of BVHs for ray-tracing is conceptually a very parallel problem. Parallelisation schemes to date have utilized many forms of parallelism, including assigning subtrees to individual cores, building single nodes using multiple cores, and parallel breadth-first schemes. Both CPU and GPU approaches have utilized such techniques.

In this context, one approach to achieving superior performance which has received comparatively little attention is the design of specialized ray tracing hardware. What research exists on this topic has looked to parallel construction on both multi-core and many-core platforms [Wald 2007; Pantaleoni and Luebke 2010; Wald 2012] and has consistently demonstrated that significant performance and efficiency gains may be achieved with purpose built microarchitectures.

Early parallel construction algorithms targeted multicore CPUs [Wald 2007]. Wald's algorithm distinguishes between the upper and lower nodes in the tree, utilising a more data-parallel approach for the upper nodes and a task parallel per-subtree scheduling for lower nodes. In addition to construction, parallel refitting techniques for BVHs have been shown on multicore CPUs [Lauterbach et al. 2006]. More recent work on multicore BVH builds include the Intel Embree set of ray-tracing kernels [Ernst 2012]. The Embree project includes support for SAH BVHs of several branching factors and is highly optimised for current generation CPUs.

A breadth-first parallelisation of binned SAH BVH construction has been shown to be effective on GPUs [Lauterbach et al. 2009]. Each child node generates a new thread in the build, allowing for a large number of concurrent threads to effectively utilize the GPU. The authors also propose an alternative hybrid LBVH/SAH scheme to extract more parallelism at the top of the tree. This work was extended to the Hierarchical LBVH, to take greater advantage of data coherence [Pantaleoni and Luebke 2010]. Other work on HLBVH includes faster and more efficient implementations [Garanzha et al. 2011; Karras 2012].

A recent implementation of binned SAH BVH construction targets the Intel MIC architecture [Wald 2012]. The tested architecture in this work consists of 32 x86 cores operating at a frequency of 1 GHz. Algorithmically, this implementation resembles earlier work [Wald 2007]. A data-parallel approach is used for large nodes, and smaller subtrees are assigned to individual threads. Furthermore, data quantization of primitives is employed to improve cache performance, at reasonable hierarchy quality degradation.

Sopin et al. describe another fast approach to binned SAH BVH construction on the GPU [Sopin et al. 2011]. Like other algorithms, this approach distinguishes between different node sizes for the purposes of more efficiently assigning tasks to the GPU architecture, utilising a larger number of cores for upper nodes, and assigning fewer cores per node as the nodes become smaller. This work is among the fastest published implementations of the binned SAH BVH construction algorithm.

The OptiX ray-tracing engine [Parker et al. 2010] provides developers with highly-optimized BVH builders for both CPU and GPU platforms, including SBVH and LBVH-type hierarchies.

However, previous work on hardware ray tracing has focused almost entirely on the traversal and intersection aspects of the processing pipeline. As a result, the critical aspect of the management and construction of acceleration data structures, remains largely absent from the hardware literature.

Another proposed approach to achieving high ray-tracing performance is with the use of specialized hardware devices. Little work to date has been performed in this area, despite a number of researchers demonstrating considerable raw performance and efficiency gains with a variety of programmable [Spjut et al. 2009], fixed-function [Schmittler et al. 2004] and hybrid architectures [Woop et al. 2005].

The SaarCOR architecture is a fixed-function design for ray tracing of dynamic scenes [Schmittler et al. 2004]. The architecture utilizes multiple units in parallel, each traversing wide packets with a kd-tree data-structure. Each unit operates on multiple packets in a multithreaded manner to hide memory latency. An FPGA prototype of this architecture has been presented, albeit requiring CPU support for data-structure construction.

More recent work on fixed-function ray-tracing hardware includes the T&I engine [Nah et al. 2011]. It is a MIMD style processor which operates on single rays, rather than packets. A ray dispatcher unit generates rays, which are passed to 24 traversal units which utilize a kd-tree data-structure. On encountering a leaf, the list units fetch primitives for intersection. Intersection is split into two units (IST 1 & 2) such that if a ray fails initial tests in IST1, data need not be fetched for the rest of the procedure in IST2. Each unit possesses a cache, and on cache misses, rays are postponed in a ray accumulation unit which collects rays waiting on the same data. Running at 500 MHz, simulations indicate that 4 T&I engines together can exceed the ray throughput of a graphics processor unit (GPU) manufactured and sold by the nVidia Corp under the model reference GTX480™ by around 5× to 10×. A ray-tracing GPU utilising the T&I engine, coupled with reconfigurable hardware shaders and a multicore ARM chip for datastructure construction, has also recently been proposed [Lee et al. 2012].

Hybrid fixed-function/programmable ray-tracing architectures have also been proposed, such as the Ray Processing Unit (RPU) [Woop et al. 2005]. Each RPU consists of multiple programmable Shader Processing Units (SPUs), which utilize a vector instruction set. Each SPU is multithreaded and avoids memory latency by switching threads when necessary. Each SPU can be used for a variety of purposes, including intersection tests and shading. SPUs are grouped into chunks containing a small number of units. All SPUs in a chunk operate together in a lock-step manner. Multiple asynchronous chunks work in parallel to complete a task. Coupled with each SPU is a fixed-function Traversal Processing Unit, which can be accessed by the SPUs via the instruction set and utilizes a kd-tree data-structure. A later version of this work, the DynRT architecture [Woop et al. 2006] is designed to provide limited support for dynamic scenes by refitting, but not rebuilding, a B-KD data-structure.

The TRaX architecture represents some of the most recent work on ray-tracing hardware [Spjut et al. 2009]. The design is programmable and consists of a number of thread processors which possess their own private functional units, but which are also connected to a group of shared functional units. Each software thread corresponds to a ray, and the design is optimised for single rays, rather than relying on coherent packets. The advantage of this architecture is that it is entirely programmable and yields good performance for ray-tracing compared to GPUs.

The Mobile Ray-Tracing Processor (MRTP) [Kim et al. 2012] is a programmable design which takes a unique hardware approach to solving SIMT/SIMD utilization problems due to divergent code. The basic architecture consists of three reconfigurable stream multiprocessors (RSMPs) which are used to execute one of three kernels: ray traversal, ray intersection and shading. Kernels can adaptively be reassigned to RSMPs to enable load balancing. Each RSMP is a SIMT processor consisting of 12 Scalar Processing Elements (SPE). Each SPEs can be reconfigured into either a 12-wide regular scalar SIMT operation, or a 4-wide 3-vector SIMT operation. To improve datapath utilization due to code divergence, the system uses the regular scalar SIMT mode for traversal and shading, and reconfigures into the vector mode for triangle intersection.

A number of commercial ventures utilising dedicated raytracing hardware have been founded, including ArtVPS [Hall 2001] and Caustic Graphics [Caustic Graphics 2012] which released cards aimed at accelerating ray-traced rendering. These cards appear also to focus on hardware for the actual tracing portion of the pipeline. However, limited technical information is publicly available on these products.

So far, these devices have relied on CPU support for acceleration data-structure construction, or have resorted to refitting operations, placing restrictions on the extent to which motion is supported and/or degrading rendering performance. Therefore, the construction of acceleration data-structures in hardware remains an open problem.

Thus, previous research has noted that high-quality acceleration datastructure construction is very computing intensive but scales well on parallel architectures [Lauterbach et al. 2009; Wald 2012]. Thus it is hypothesized that a custom hardware solution to acceleration data-structure construction would represent a highly efficient alternative to execution of the algorithm on a multi-core CPU or many-core GPU if used in the context of a heterogeneous graphics processor.

Recent research argues that multi-core scaling is power limited due to the failure of Dennard scaling [Esmaeilzadeh et al. 2011]. Esmaeilzadeh et al. show that at 22 nm, 21% of a fixed-size chip must be powered off, and at 8 nm, it could be more than 50%. This had led some to coin the expression “dark silicon”, for logic which must remain idle due to power limitations. In response to this, some researchers have proposed that efficient custom microarchitectures could help heterogeneous single-chip processors to reduce future technology imposed utilization limits [Venkatesh et al. 2010; Chung et al. 2010]. It is now a matter of identifying the most suitable algorithms for custom logic implementation for the ages of dark silicon.

### SUMMARY OF THE INVENTION

The present invention provides a specialized data processing hardware architecture, which achieves considerable performance and efficiency improvements over programmable platforms.

According to an aspect of the present invention, there is provided a graphics data processing architecture for constructing a hierarchically-ordered acceleration data structure in a rendering process, comprising at least two builder modules, consisting of at least a first builder module configured for building a plurality of upper hierarchical levels of the data structure, connected with at least a second builder module configured for building a plurality of lower hierarchical levels of the data structure. Each builder module comprises at least one memory interface comprising at least a pair of memories; at least two partitioning units, each connected to one respective of the pairs of memories and configured to read a vector of graphics data primitives therefrom and to partition the primitives into one of two new vectors according to which side of a splitting plane the primitives reside; at least three binning units connected with each partitioning unit and the memory interface, one binning unit for each of the threes axes X, Y and Z of a three-dimensional graphics scene, and each configured to latch data from the output of the pair of memories and to calculate and output an axis-respective bin location and the primitive from which the location is calculated; and a plurality of calculating modules connected with the binning units for calculating a computing cost associated with each of a plurality of splits from the splitting plane and for outputting data representative of a lowest cost split.

In an embodiment of the architecture according to the invention, each calculating module comprises a plurality of buffer-accumulator blocks, one for each binning unit, wherein each block comprises three buffer-accumulators per block, one for each of the threes axes X, Y and Z, and wherein each block is configured to compute a partial vector; a plurality of merger modules, each respectively connected to the buffer-accumulators associated with a same axis X, Y or Z and wherein each merger unit is configured to merge the output of the blocks into a new vector; a plurality of evaluator modules, each connected to a respective merger module and wherein each evaluator module is configured to compute the lowest computing cost based on the new vector; and a module connected to plurality of evaluator modules and configured to compute the global lowest cost split based on the computed lowest computing costs in all three axes X, Y and Z.

In an embodiment of the architecture according to the invention, the first builder module is a an upper builder and each memory of the pair thereof comprises a dynamic random access memory (DRAM) module. In a variant of this embodiment, the upper builder is configured to read primitives in bursts and to buffer writes into bursts before they are requested.

In an embodiment of the architecture according to the invention, the second builder module is a subtree builder and each memory of the pair thereof comprises a high bandwidth/low latency on-chip internal memory configured as a primary buffer. In a variant of this embodiment, each primary buffer has a die area of 0.94 mm² at 65 nm. In a further variant, the subtree builder module has a die area of 31.88 mm² at 65 nm.

In an embodiment of the architecture according to the invention, the hierarchically-ordered acceleration data structure is a binary tree comprising hierarchically-ordered nodes, each node representing a bounding volume which bounds a subset of the geometry of the three-dimensional graphics scene to be rendered. In a variant of this embodiment, a data width of the memory interface is sufficiently large for a full primitive of an axis-aligned bounding box (AAB) to be read in each data processing cycle. In a further variant, the hierarchically-ordered acceleration data structure comprises binned Surface Area Heuristic bounding volume hierarchies (‘SAH BVH’).

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a logical diagram of a hardware architecture of a graphics data processing device including a video graphics adapter.

FIG. 2 is a logical diagram of a graphics data processing architecture embodied in the video graphics adapter of FIG. 1, including a plurality of memory interfaces, an upper builder and a plurality of subtree builders adapted to construct binned SAH BVH.

FIG. 3 is a logical diagram of a subtree builder shown in FIG. 2, including buffers, partitioning units, binning units and SAH calculators.

FIG. 4 is a logical diagram of a SAH calculator shown in FIG. 3.

FIG. 5 is a graph charting the scalability of the architecture of FIGS. 1 to 4 in the Cloth scene.

### DETAILED DESCRIPTION OF THE EMBODIMENTS

There will now be described by way of example a specific mode contemplated by the inventors. Other embodiments may be used in addition or instead. Details which may be apparent or unnecessary may be omitted to save space or for a more effective presentation. Conversely, some embodiments may be practiced without all of the details which are disclosed. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

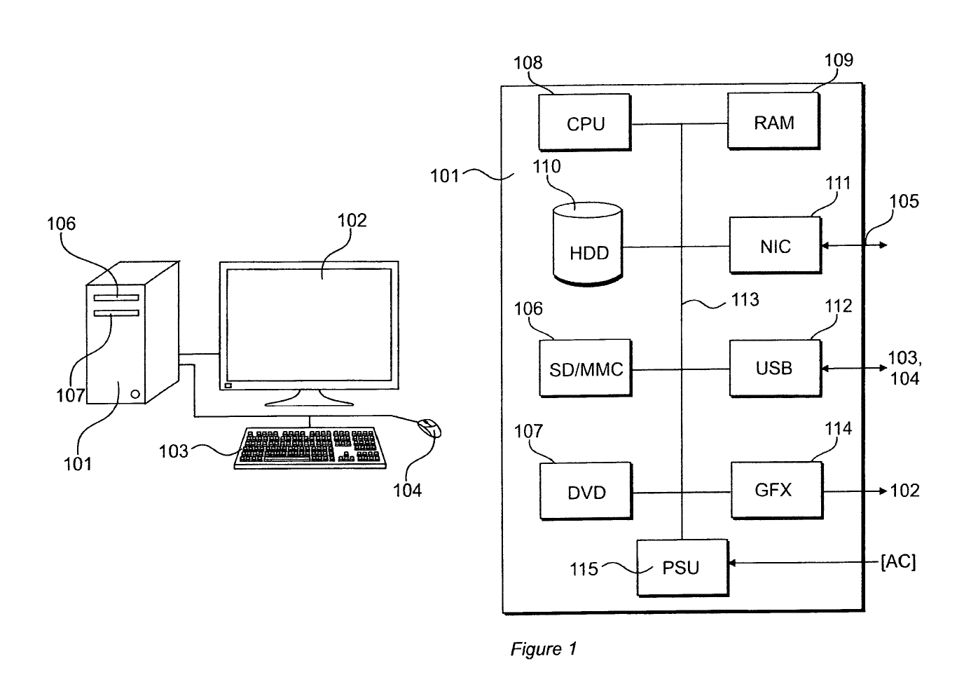

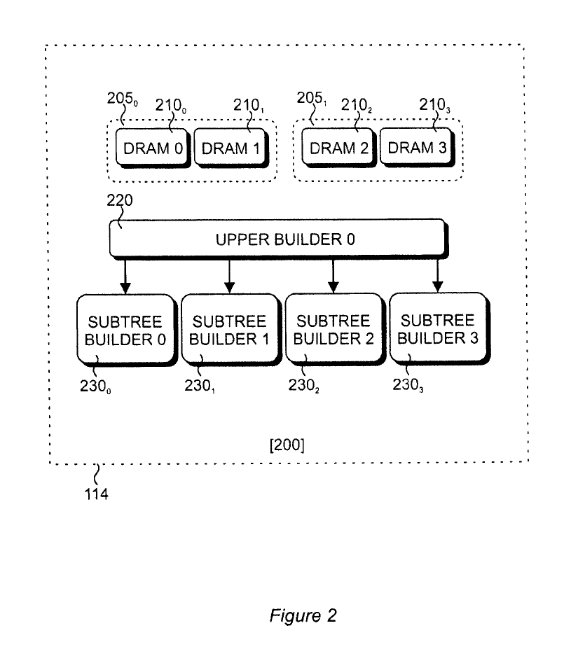

With reference to FIG. 1, a hardware architecture of a graphics data processing device is shown by way of non-limitative example, configured with an embodiment of the inventive principles disclosed herein as further detailed with reference to FIGS. 2 to 4. The data processing device is a computer configured with a data processing unit 101, data outputting means such as video display unit (VDU) 102, data inputting means such as HiD devices, commonly a keyboard 103 and a pointing device (mouse) 104, as well as the VDU 102 itself if it is a touch screen display, and data inputting/outputting means such as a magnetic data-carrying medium reader/writer 106 and an optical data-carrying medium reader/writer 107.

Within data processing unit 101, a central processing unit (CPU) 108 provides task co-ordination and data processing functionality. Sets of instructions and data for the CPU 108 are stored in memory means 109 and a hard disk storage unit 110 facilitates non-volatile storage of the instructions and the data. A wireless network interface card (NIC) 111 provides an interface for a network connection. A universal serial bus (USB) input/output interface 112 facilitates connection to the keyboard and pointing devices 103, 104.

All of the above components are connected to a data input/output bus 113, to which the magnetic data-carrying medium reader/writer 106 and optical data-carrying medium reader/writer 107 are also connected. A video graphics adapter 114 receives CPU instructions over the bus 113 for outputting processed data to VDU 102. All the components of data processing unit 101 are powered by a power supply unit 115, which receives electrical power from a local mains power source and transforms same according to component ratings and requirements.

With reference next to FIG. 2 next, in the embodiment the video graphics adapter 114 is configured with a graphics data processing architecture 200 including a plurality of distinct components. The architecture firstly comprises a DRAM interface consisting of a number of RAM pairs 205_{N}. Each RAM pair 205_{N} consists of two memory channels 210_{N}, 210_{N+1}. Before construction begins, scene primitives are divided over the RAM pairs 205_{N}, with one RAM 210_{N} in each pair holding primitives.

Below the RAM pairs, is the upper builder 220. The upper builder 220 reads and writes directly to DRAM 210_{N} and is responsible for constructing the upper levels of the hierarchy. Connected to the upper builder 220 is one or more subtree builders 230_{N}. The subtree builders 230_{N} are responsible for constructing the lower levels of the hierarchy.

The upper builder 220 continues building until a node smaller than a predetermined size is found (typically, several thousand primitives). The primitives corresponding to this node are then loaded into one of the subtree builders 230_{N}, which contains a set of high bandwidth/low latency on-chip internal memories. The subtree builder 230 builds a complete subtree from these primitives. Once all primitives are passed to a subtree builder 230, the upper builder 220 continues building its upper hierarchy, passing further subtrees to the other subtree builders 230_{N}+₁, stalling if none are available. The upper and subtree builders 220, 230_{N} therefore operate in parallel.

The upper and subtree builders are largely the same hardware, except that the upper builder 220 interacts with external DRAM 205, 210_{N}, whereas the subtree builders 230_{N} interact with their internal memory buffers 310_{N}. The core logic of a subtree builder 230 is actually mostly a superset of the upper builder 220. Therefore, we first describe in detail the subtree builder 230, and then describe how it differs from the upper builder 220.

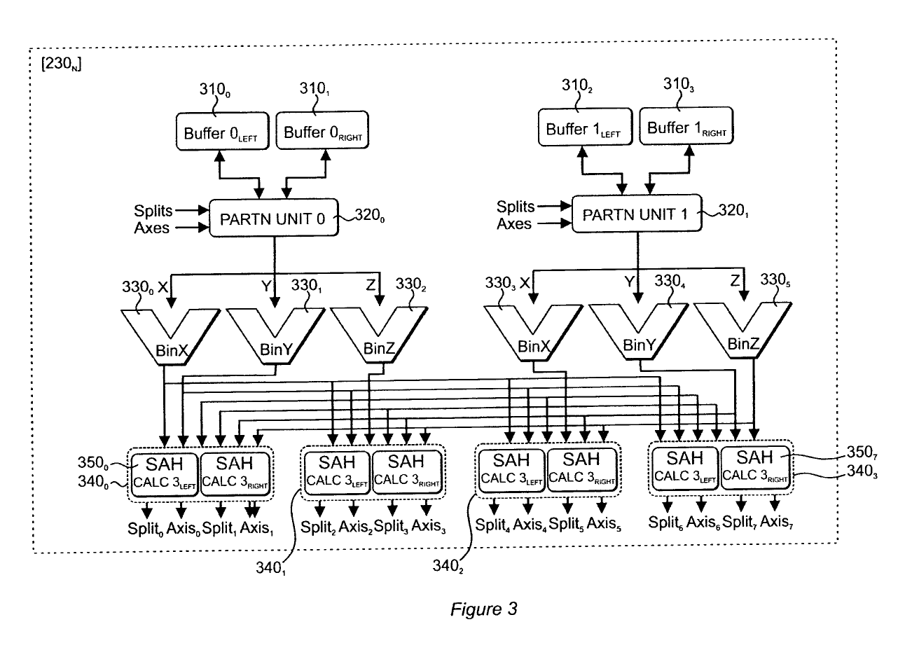

An embodiment of an architecture for a subtree builder 230 is shown in FIG. 3. A relatively small instantiation is illustrated, for the purpose of not obscuring the Figure and the present description unnecessarily. The architecture is designed to operate on the AABBs of scene primitives, as is common with other hierarchy builders, and is therefore suitable for any primitive type for which an AABB can be calculated.

The subtree builder 230 implements a typical binned SAH recursive BVH construction algorithm, in line with established best practices [Wald 2007]. The subtree builder 230 consists of a number of units which implement the various stages of this recursive algorithm. The first units of interest are the partitioning units 320_{N}. Two partitioning units 320₀, 320₁ are visible in FIG. 3, respectively labeled PARTN UNIT 0 and PARTN UNIT 1. The purpose of the partitioning units 320_{N} is, given a split in a certain axis, to read a vector of primitives from the internal buffers 310_{N} and partition those primitives into one of two new vectors, depending on which side of the splitting plane they reside.

Each partitioning unit 320_{N} is connected to a pair of primitive buffers 310_{N}, 310_{N+1}. Two pairs 310₀, 310₁ and 310₂, 310₃ are shown in FIG. 3, and are respectively labeled BUFFER 0 and BUFFER 1. The primitive buffers 310_{N} are a set of on-chip, high bandwidth/low latency buffers (similar to a cache memory). The purpose of the primitive buffers 310_{N} is to hold primitive AABBs as they are processed by the partitioning units 320_{N}. Each buffer pair 310_{N}, 310_{N+1} is hardwired to one partitioning unit 320.

Primitive buffers 310_{N}, 310_{N+1} are organised in pairs to facilitate swift partitioning of AABBs. When the upper builder 220 loads a set of scene primitives into the subtree builder 230, the primitives are distributed to one of the buffers 310_{N}, 310_{N+1} from each buffer pair, with the opposite buffer 310_{N+1}, 310_{N} in each pair left empty. The partitioning units 320_{N} read AABBs from one of buffers 310_{N}, 310_{N+1} and rewrite the AABBs in the new partitioned order to the opposite buffer 310_{N+1}, 310_{N}.

On the next recursive partitioning, the roles of the buffers are reversed, and the primitives are read from the buffer they were last written. This back-and-forth action allows concurrent reading and writing of primitives which leads to swift primitive partitioning.

The data width of the interface to these buffers 310_{N}, 310_{N+1} is set large enough for a full primitive AABB to be read in each cycle. They could also be implemented with several narrower memories in parallel. Below the partitioning units 320_{N} in FIG. 3 is the logic which determines the SAH split for the current node. The subtree builder 230 is capable of searching all three axes X, Y, and Z concurrently for the lowest cost split.

The SAH determination is implemented with two types of unit: a binning unit 330_{N} and an SAH calculator 350_{N}. Each partitioning unit 320_{N} is connected to three binning units 330_{N}, 330_{N+1} and 330_{N+2}, one for each axis X, Y and Z and respectively labeled Bin X, bin Y and Bin Z in FIG. 3. The binning units 330_{N} latch data from the output of primitive buffers 310_{N}, and also keep track of the AABB of the current node. The binning operation is performed by calculating the centre of the primitive AABBs and then binning this centre point into the AABB of the current hierarchy node. The binning units 330_{N} output the chosen bin locations to SAH calculators 350_{N} in all three axes, and also the original primitive AABB which was used to calculate those bin locations.

Accordingly the SAH calculators 350_{N} are shown below the binning units 330_{N} in FIG. 3, and number 8 units in this embodiment. Primitive AABBs and their chosen bin positions are fed into the SAH calculators 350_{N} which accumulate an AABB and a counter for each bin 330_{N} in each axis X, Y and Z.

Once all primitives are accumulated, the SAH calculators 350_{N} evaluate the SAH cost for each possible split, and output the lowest cost split found.

Once the split has been chosen, it is fed back to the partitioning units 320_{N} which partition the primitives in their primitive buffers 310_{N} according to the split. The SAH evaluation is expensive, and the design is multithreaded to hide the latency of this unit.

Further to the description of the function of each component of the architecture, the sequence of operations which the subtree builder 230 performs for generating a hierarchy will now be described in further details. Sequencing of operations is performed by the Main Control Logic.

Before the subtree builder 230 is activated, the upper builder 220 loads AABBs combined with their primitive IDs (as a single data word) into one of the primitive buffers 310_{N}, 310_{N+1} in each buffer pair in a round-robin assignment (i.e. the left buffer 310₀, 310₂ only of each pair, leaving the right buffer 310₁, 310₃ empty). This results in an approximately equal number of primitives per buffer pair, facilitating load balancing. Primitive IDs are always attached to their associated AABBs as they move between primitive buffers, and are used for tree output. The bounding AABB of all primitives is also loaded into a register at this point. Once all primitives are loaded, an initial setup phase is run.

All partitioning units 320_{N} are signalled to dump the full contents of their primitive buffers 310_{N} into the binning units 330_{N}. The results of the binning units 313_{N} are fed into a single SAH calculator 350_{N} which calculates the split for the root of the hierarchy. The output of the SAH calculator 350_{N} is the chosen SAH split, the chosen axis and, importantly, the AABBs and primitive counts of the two resulting child nodes. Once these values are obtained, the main construction loop can proceed.

The initial split phase produces the split for the root node. Each partitioning unit 320_{N} is then instructed to begin the main construction loop of the builder. Each partitioning unit 320_{N} possesses in its buffer pair 310_{N}, 310_{N+1} a subset of the total primitives which must be partitioned according to the split. Each of the partitioning units 320_{N}, 320_{N+1} cooperate to partition all primitives in a data-parallel manner. Each partitioning unit 320_{N} reads its subset of primitives pertaining to the current node from one of the buffers 310_{N}, 310_{N+1} in its buffer pair.

The partitioning unit 320_{N} then determines on which side of the current splitting plane each primitive lies, and then writes the primitives out in partitioned order into the opposite buffer. Partitioning is achieved by maintaining two address registers, a lower and an upper register, inside each partitioning unit 320_{N}. The lower and upper registers begin at the bottom and top address respectively of the subset of primitives that belong in the node currently being processed. These registers are then multiplexed onto the address of the primitive buffer as appropriate.

After a partition, each partitioning unit 320_{N} has two sublists of primitives residing in its primitive buffers 310_{N}, 310_{N+1}. To continue the recursive procedure, processing must continue with one of these sublists, with the other placed on a stack for future processing. Since there are several partitioning units 320_{N} all partitioning a subset of the current node's primitives in their respective buffers 310_{N}, there are several partitioned lists which, when added together, form the full list. A wide stack is used to keep track of this information. Wide stack elements include the full AABB of the pushed node, and also separate primitive ranges for each primitive buffer pair detailing where all primitives reside. The stack also stores on which “side” of the primitive buffer pair 310_{N}, 310_{N+1} the primitives of interest reside.

When the partitioning units 320_{N} encounter a leaf, instead of recursing again and writing the primitives back into the opposite buffer 310_{N}, they write the primitive IDs into separate output FIFOs. Tree nodes are also written into similar FIFOs. Nodes and primitive IDs are then collected from these FIFOs and written out to RAM 310_{N}.

In addition to partitioning the primitives of the current node, it is also necessary to calculate the splits for these two new nodes. As partitioning is taking place, this signifies that the SAH split information is at hand, which includes the AABBs of the two resulting child nodes. Therefore, all the necessary information is at hand to begin binning primitives into the new children concurrently whilst they are being partitioned. During partitioning, primitives are not only written into the opposite buffer 310, but are also fed into the binning units 330_{N}. The binning units 330_{N} bin each primitive into either the left or right child, depending on which side of the partition it belongs to, by multiplexing the correct values into the pipeline.

The binning units 330_{N} output the bin decisions and primitive AABBs which are then fed into one of the SAH calculator pairs 340_{N} as shown at the bottom of FIG. 3. SAH calculators 350_{N} are placed in pairs 340_{N}, one for each side of the split. If a primitive was on the left side of the split in the previous node, it is fed into the left SAH calculator 350_{N} of the pair 350_{N}, 350_{N+1}, otherwise the right 350_{N+1}. Both calculators 350_{N}, 350_{N+1} in a pair 340_{N} operate concurrently.

As each partitioning unit 320_{N} processes a subset of the node's primitives, each SAH calculator 350_{N} must monitor the output of each binning unit 330_{N} (each set of three binning units 340_{N}, 340_{N+1} and 340_{N+2} are assigned to a partitioning unit 320_{N} which is assigned to a primitive buffer pair 310_{N}, 310_{N+1}. After calculating the splits, processing continues with a valid child, normally the left, while the right split information is pushed to the stack for later processing. If the node is a leaf, the stack is popped. This stack contains the split, the axis, the AABB of the node, the resulting child AABBs and primitive counts, the ranges in the primitive buffers corresponding to the node, and a single bit indicating on which side of the primitive buffers the node's primitives reside

Once the partitioning units 320_{N} pass all of their primitives into the binning units 330_{N}, they must wait for all of them to be binned and for the SAH calculator 350_{N} to return the next split, so that they may begin partitioning again. In the implementation, the total combined latency of the binning and SAH units 330_{N}, 350_{N}, is approximately 40 cycles. Stalling would represent a large performance penalty, because it would be incurred on every node of the tree. Instead, the latency of the SAH calculation is hidden by taking a multithreaded approach that utilizes several SAH calculators 350_{N}.

Context is allowed for multiple threads to be maintained in the system, as shown in the upper half of the Figure. Initially, there is only one thread in the system, representing the root node. As new child nodes are created, these are spawned off as new threads, until a predetermined number of threads is reached. Each thread context stores the ranges in each of the primitive buffers 310_{N} of the primitives in the thread, a split, a stack and stack pointer, an axis and a node AABB (thread elements are similar to stack elements). The new threads represent different subtrees. Each new thread that is created is assigned to a pair 340 of SAH calculators 350_{N}, 350_{N+1}

Each partitioning unit 320_{N} will hold a subset of the primitives in each thread due to the round-robin assignment in the beginning. When a partitioning unit 320_{N} finishes partitioning a node, instead of stalling for the SAH calculation, it can switch context to the next thread in the system. Once it has completed the last thread, it can return to the first thread for which the split will now be ready. The round robin assignment means that partitioning units 320_{N} are therefore almost always utilized (even when only one thread is present) and additionally that the system is load balanced as the assignment leads to a roughly equal amount of primitives belonging to each thread in each partitioning unit 320_{N}.

As previously noted, the upper builder 220 and the subtree builder 230 are very similar. The upper builder 220 also contains partitioning units 320_{N}, binning units 330_{N} and an SAH calculator pair 340, which are only slightly modified relative to their counterparts in a subtree builder 230. The difference between the subtree builder 230 and the upper builder 220 lies in that the upper builder 220 contains no multithreading support (only one thread context) and utilizes the RAM pairs 205_{N} in place of the partitioning buffer pairs 310_{N}, 310_{N+1}. It achieves efficient use of DRAM 210_{N} by reading primitives in bursts and buffering writes into bursts before they are requested.

Multithreading is unnecessary for the upper builder 220 because it constructs only the uppermost nodes of the hierarchy, which contain possibly thousands of primitives which are read in long streaming consecutive reads. Therefore, the stall incurred by waiting on the SAH calculator 350 (around 40 cycles) is negligible and the skilled person will understand that, in this embodiment, it is not necessary to spend resources on multithreading for the upper builder 220.

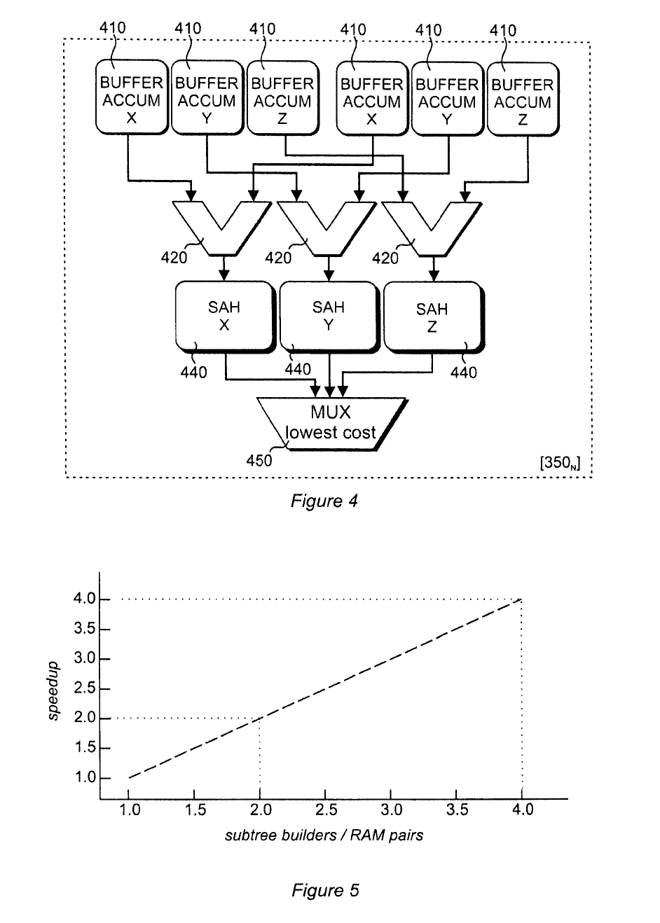

With reference to FIG. 4 next, SAH calculators 350 are described in more detail by way of an example block diagram for an SAH calculator unit. The input to the SAH calculator 350 is a vector of AABBs and a vector of bin decisions. Each AABB and each bin of these two vectors comes from a separate binning unit 330_{N}. The first stage of the SAH calculator 350 consists of multiple blocks of buffer/accumulators 410. One block exists for each binning unit 330_{N} in the design.

There are three buffer/accumulators 410 per block, one for each axis. The purpose of the buffer/accumulator 410 is to take a sequence of primitive AABBs and bin decisions from the binning units 330_{N} and accumulate the bin AABBs and bin counts from this sequence into a small buffer. As each buffer/accumulator block processes primitives from one binning unit 330_{N}, it computes a partial vector. The current subtree builder 230 utilizes 16 bins per axis, making one buffer accumulator 410 416 bytes in size.

Once all primitives have been accumulated, each buffer/accumulator 410 is instructed to dump its contents in order. The contents of all blocks are then merged into a new vector containing the complete bin AABBs and counts by the units labeled 420. There is a separate list of bins for each axis X, Y and Z, so there are three such units 420 in the diagram. These three lists are then fed into three SAH evaluators 440 (one per axis), which perform the actual SAH evaluation and keep track of the lowest cost split so far. The output of each evaluator 440 is the lowest cost split in that axis. Finally, the global lowest cost split is computed in a multiplexing unit 450 by examining these three values and the SAH calculator 350 signals to the rest of the circuit that the split is ready.

The architecture of FIGS. 2 to 4 was implemented as a cycle-accurate, synthesizable VHDL model at the RTL level for evaluation purposes. All results were simulated with Questasim 6.6 from Mentor Graphics. To model the floating-point units, the Xilinx Floating-Point library available with the Xilinx ISE development software was used. These cores were chosen as having realistic properties and being proven in real chips, in addition to providing prompt adaptability of the design to reconfigurable systems. The simulations allowed a count of the exact duration of the computation in clock cycles. The code was highly configurable, allowing attributes such as the number of partitioning units, the number of threads, bin sizes etc to be altered independently. There is therefore a large number of possible instantiations of the subtree builder 230.

A “standard instantiation” was presented for each subtree builder 230, which utilizes four partitioning units 320 and sixteen SAH calculators 350 (eight threads). Primitive buffers 310 were set to hold 2048 primitives each, yielding a maximum capacity for each subtree builder 230 of 8192 primitives. These buffers were modeled with Xilinx Block RAM primitives, which are single ported RAMs with a memory width of 216 bits (one 32-bit floating-point AABB and one primitive ID), a latency of one cycle, and a throughput of one word per cycle. The total capacity of the eight buffers was therefore 432 KB and the maximum internal bandwidth was 216 bytes/cycle. Two such subtree builders 230 were instantiated for the performance comparisons in Table 1 hereunder.

For the upper builder 220, an instantiation was chosen which utilizes two RAM pairs 205₀, 205₁ (four DDR ports) which determines an upper builder 220 with two partitioning units 320₀, 320₁, two binning units 330₀, 330, and one SAH calculator pair 340 (350₀, 350₁). The simulation aimed to estimate the performance of the design if implemented in a dedicated ray-tracing or other graphics processor, whereby the assumptions made by earlier work on ray-tracing hardware [Spjut et al. 2009; Nah et al. 2011] were followed, thus assuming a 200 mm² die space at 65 nm and a clock frequency of 500 MHz. This is 2.8 times lower than the shader cores of a GPU 114 marketed by the nVidia Corporation under the model reference GTX480™, which is the part of the GPU used by all hierarchy construction implementations on that platform.

The DRAM interfaces were modeled with a generic DDR model from DRC computer written in Verilog. This DDR model provides an interface with address and data lines, a read/write signal, burst length etc. Each DRAM at peak is capable of delivering one 192-bit word per cycle and also operates at 500 MHz. The total bandwidth to each DRAM in the simulations was just over 11 GB/s, and with the four ports (two RAM pairs 205₀, 205₁) was thus 44 GB/s max, although the logic does not request this value for much of the BVH construction. This value is only a fraction of what can be found on a modern mid-range GPU 114.

The microarchitecture is intended to reside on-chip with the rendering logic and therefore any communications with a host CPU 108 or GPU 114 were not timed. Binning was always with 16 bins on all three axes X, Y and Z terminating at four triangles per leaf. Comparison were drawn to both full binned SAH BVH implementations as well as lower quality hybrid SAH builders. In all cases, the simulated embodiment was compared to the highest-performing software implementations known to exist. Simulating the hardware was a time-consuming process (several days for one build), whereby it was not possible to build all frames of the animated test scenes (e.g. Cloth). Therefore, the middle keyframe from these animations was chosen by way of comparison point

Table 1 hereunder summarizes the performance results and illustrates absolute build times in milliseconds and bandwidth usage for the BVH builder compared to software implamentations. A dash (-) indicates that the scene was not tested in that work.

TABLE 1

| | Partitioning | Binning | SAH | Design |
|---|---|---|---|---|
| | Units | Units | Calculators | Total |
| # Used | 4 | 4 | 15 | |
| FP ADD | 1 | 3 | 9 | 160 |
| FP SUB | 3 | 9 | 9 | 192 |
| FP MUL | 2 | 6 | 12 | 224 |
| FP INV | 1 | 3 | 0 | 16 |
| FP CMP | 0 | 0 | 144 | 2304 |
| Registers | 80 KB | 4 KB | 9 KB | 480 KB |

The implementation exhibits strong performance relative to the two full binned SAH implementations. A raw performance improvement of approximately 4× to 10× is notable over these many-core implementations. With HLBVH, a direct comparison is difficult because they are two different algorithms. The original idea of HLBVH was to remove much of the expensive SAH calculation in order to improve performance, whilst preserving reasonable quality. As a result of this, HLBVH is typically 10× to 15× faster than binned SAH on the same GPU. Regardless, the architecture 200 of the invention is demonstrably faster for the Conference scene than HLBVH when measured by performance per clock cycle (extrapolating from the clock frequency of the GPU and the build time).

Overall, the skilled reader can observe that the implementation can deliver high-quality, high-performance builds at speeds faster than current many-core implementations. The high performance is considered to be achieved through the low-latency/high-bandwidth primitive buffers 310_{N} delivering very efficient streamed data access for the rest of the circuit, which consists of a set of very fast dedicated units for the expensive SAH evaluation and binning.

The simulations were also instrumented to record the total bandwidth consumed over hierarchy construction. These values are shown in Table 1, and include reads and writes. Bandwidth figures are typically not given in hierarchy construction disclosures, and the only figures that could usefully be found were those of the original HLBVH [Pantaleoni and Luebke 2010]. The architecture 200 exhibits approximately 2× to 3× less bandwidth consumed than this prior art implementation. The high performance is considered to be achieved because only the uppermost levels of tree are built in external DRAM 210_{N}, and the tree is output during construction. No other values are read or written to DRAM 210_{N}. Moreover, the memory footprint is also quite low, with the peak footprint being twice the scene size, which corresponds to about 40 MB for the Dragon scene, excluding the tree itself. These bandwidth and footprint savings would be an advantage when running other tasks in parallel with the builder, such as concurrent rendering/hierarchy construction.

FIG. 5 charts the scaling for the Cloth scene in the builder. The process begins with one subtree builder 230 and one RAM pair 205, and scale to four subtree builders 230₀-230₃ and four RAM pairs 205₀-205₃, doubling the size each time (i.e. 1, 2 and 4 subtree builders/RAM pairs 230, 205). As the graph shows, the scalability is appreciable over the three instantiations, and is very close to linear within this range. Very little overhead is associated with assigning tasks to subtree builders 230_{N}, and design is naturally load balanced as subtree builders 230_{N} only ask for work when idle.

The SAH computational cost of the trees produced by the present BVH builder was also calculated, and compared to prior art implementations in Table 2. Sopin et al did not provide tree quality measurements in their work, but their tree costs would probably compare quite closely to the present techniques, as a similar approach is used. Tree costs for HLBVH were taken from both the original HLBVH by Pantaleoni and Luebke and also Garanzha et al. so as to provide more data points for comparison. The original HLBVH used a sweep build for the upper levels rather than a binned builder, so these figures should be at least as good or better than Garanzha et al. Wald 2012 gives cost ratios compared to a binned builder with a large number of bins, whereas the present comparison is to a full sweep builder. Although running simulations was extremely time consuming, the CPU builder was used, which provided identical output to the hardware for obtaining high quality results.

TABLE 2

| | | [Pantaleoni | |
|---|---|---|---|
| Scene | [Wald 2012] | & Luebke 2010] | Present solution |
| Toasters | — | — | 99% |
| Cloth | — | — | 101% |
| Conference | 101% | 117% | 114% |
| Exp. Dragon | 103% | — | 105% |
| Armadillo | — | 109% | 101% |
| Dragon | — | 112% | 101% |

The builder of the present technique follows precisely a classical binned SAH build, with no adjustments, thus ensuring high quality. The only builder in the comparison for which this is also true is Sopin et al, as Wald performs quantization of vertices and HLBVH methods only perform the SAH on a small fraction of the nodes the SAH cost are therefore expressed as a ratio to a full SAH sweep build, with the sweep build cost set at 100% and lower values considered better.

As Table 2 shows, high tree quality is exhibited, with tree costs quite close to a full sweep build in many cases. This ensures high efficiency in rendering, which represents a further performance advantage that the architecture 200 can offer, along with minimising hardware resources and very fast build times. The exception to this is the Conference scene, which is not surprising as other authors have reported lower quality with this scene in binned SAH builders [Wald 2007; Lauterbach et al. 2009].

Finally, the hardware resources required for the microarchitecture 200 were estimated. The resources required for the subtree builder were first estimated, as it represents the majority of the architecture. Table 3 shows the required number of floating-point cores and register space needed for each major design unit in the subtree builder 230.

TABLE 3

| | Intel MIC | nVidia GTX480 | nVidia GTX480 | Hardware BVH | |
|---|---|---|---|---|---|
| | 1000 Mhz | 1400 Mhz | 1400 Mhz | 500 Mhz | |
| | [Wald | [Sopin et | [Garanzah et | [present | Hardware BVH |
| Scene | 2012] | all 2011] | all 2011] | solution] | BW usage |
| Toasters (11k) | 09 ms | 13 ms | — | 1 ms | 02 MB |
| Cloth (92k) | 19 ms | 19 ms | — | 3 ms | 25 MB |
| Conference (282k) | 41 ms | 98 ms | 6.2 ms | 11 ms | 120 MB |
| Dragon (871k) | — | — | 8.1 ms | 30 ms | 380 MB |

These values in themselves represent a technology-generic expression of required resources. Using this tabulation, the procedures of earlier work [Nah et al. 2011] were closely followed and published figures on a 65 nm library [Spjut et al. 2009] were used to perform an area estimate of the architecture 200. Table 4 summarizes the results and illustrates total area estimation of the subtree builder 230 of the present system.

TABLE 4

| Unit Type | Area (mm²) | # used | Total area (mm²) |
|---|---|---|---|
| FP ADD | 0.003 | 160 | 0.48 |
| FP SUB | 0.003 | 192 | 0.58 |
| FP MUL | 0.01 | 224 | 2.24 |
| FP INV | 0.11 | 16 | 1.76 |
| FP CMP | 0.00072 | 2304 | 1.66 |
| REG 4K | 0.019 | 120 | 2.28 |
| Primary Buffer | 0.94 | 8 | 7.52 |
| Control Logic | 2.35 | — | 2.35 |
| Wiring | 13.02 | — | 13.02 |
| Total | | | 31.88 |

A requirement for a register space equivalent to 120 4 KB registers (included in this 65 nm library) was determined. The other major component of the subtree builder 230 being the primitive buffers 310_{N} and, considering the similarity between a cache memory and the primitive buffers 310_{N}, these were modelled using the CACTI cache modelling software as a direct-mapped cache (cache size 55296 bytes, line size 27 bytes, associativity 1, number of banks 1, and technology 65 nm). This was probably an overestimate, as the primitive buffers 310_{N} are simple RAMs and do not require any caching logic. The CACTI tool reported a size of 0.94 mm2 for one buffer 310.

As control logic also requires resources, estimates were again based on earlier work [Nah et al. 2011; Muralimanohar et al. 2007] and this was modeled as 35% overhead of the FP cores. Finally, the same estimate as these authors was also chosen for wiring overhead, at 69%. The total die space of the subtree builder 230 was thus estimated to be 31.88 mm² at 65 nm, or 16% of the conservative 200 mm² assumed die size, and only around 6% of the GTX480's die size, which actually a smaller feature size of 40 nm [nVidia, 2010] whereby the design would probably consume even less than this.

Comparing to the T&I engine [Nah et al. 2011], one builder is about 2.6× the size of a T&I core, which consumes 12.12 mm2. Four T&I cores at 500 MHz yield a 5× to 10× performance increase over a GTX480 GPU implementation in terms of ray throughput. Table 1 shows that a similar factor can be obtained for building binned SAH hierarchies with only two subtree builders 230₀, 230₁. Performing a similar analysis reveals that the upper builder 220 only adds about another 5 mm2 to this, whereby the resource consumption is demonstrably comparable to this traversal engine.

The present invention thus provides a hardware architecture which yields performance improvements of up to 10× relative to current binned SAH BVH software implementations, and significant performance improvements over some less accurate SAH builders. This is achieved despite the fact that the results are measured with large clock frequency, bandwidth, and die area disadvantages compared to current multi-core and many-core processors.

Since the architecture achieves a performance improvement with much fewer hardware resources, it represents a large efficiency improvement over existing software approaches. Existing software methods scale quite well, and require engaging a large amount of programmable resources to achieve optimal performance. Utilising the design in a heterogeneous single-chip processor is expected to minimize the hardware resources needed to achieve fast builds. Since BVH construction is a core algorithm in ray-traced rendering, the design could have performance implications not only for the BVH build, but also for the rest of the application pipeline.

The present architecture requires much less bandwidth to main memory and requires a small memory footprint for hierarchy construction compared to software approaches. These bandwidth savings could be used to support the additional parallelism already stated.

The architecture is quite scalable and can achieve full binned SAH rebuilds with performance similar to many software updating strategies, whilst remaining within modest area and bandwidth costs. This ensures higher quality trees, much fewer edge cases and suitability for applications where updating may not be appropriate (e.g. photon mapping). Full rebuilds also do not limit scene motion in any way, in contrast to updating schemes.

By this reasoning, there may be significant motivation for including hardware support for acceleration data-structure construction in a heterogeneous graphics processor. It is expected that such logic may coexist with, and complement, t programmable components to form a hybrid rendering system. This is similar to how current rasterization-based GPUs operate.

It is important to consider the advantages of the present system compared to refitting operations. For deformable scenes, refitting methods are quite useful, but exhibit a few drawbacks. Firstly, refitting usually results in lower quality trees. Secondly, these approaches can exhibit edge cases, where performance diminishes to the point where full rebuilds actually give a faster time to image [Lauterbach et al. 2006; Kopta et al. 2012]. Furthermore, the system is already competitive with these schemes. For example, the Cloth scene is built in 3 ms with the present architecture, whereas recent rotation methods spend around 2.98 ms in updating this scene [Kopta et al. 2012]. Finally, there are applications (e.g. photon mapping) where refitting may not be appropriate.

The HLBVH method is probably the fastest software method known for building BVHs. However, like refitting, it results in lower quality trees (with SAH costs of around 110%-115%). As already stated, it is possible to construct a hierarchy in many cases in fewer clock cycles than a GPU implementation of HLBVH with the present architecture, despite all of the hardware resource disadvantages and using a much more expensive algorithm. Interestingly, the HLBVH performs a similar binned SAH for the upper levels of the hierarchy, consuming as much as 26% of the build time [Garanzha et al. 2011]. The skilled person could envision the builder as part of a hardware or hybrid hardware/software solution to HLBVH also. The work would be an ideal starting point for further research on the hardware implementation of HLBVH or other algorithms.

The microarchitecture of the invention is considered as a fixed-function module that could be integrated into any heterogeneous computing platform, especially a ray-tracing GPU. The design could represent a full BVH construction subsystem in itself, or be part of a larger subsystem that is capable of building different types of data-structure.

An important consideration for any data processing architecture is power consumption, and indeed power is likely to dominate architecture designs in the near future. To perform a more one-to-one comparison of power efficiency, the design presented in FIGS. 2 to 4 was scaled down such that its performance would match approximately the two full binned SAH implementations in Table 1. This resulted in an instantiation of only one RAM pair 205 and one subtree builder 230, operating at the slower speed of 250 MHz. The subtree builder 230 in this instance used the same parameters as the embodiment shown in FIG. 3 (number of units, threads, etc).

The first such characteristic is clock frequency. Power consumption is linearly dependent on clock frequency. A value of 250 MHz is only one quarter the speed of an Intel MIC and around one fifth the speed of the shader cores of the GTX480.

The second characteristic of the design is its estimated circuit size as shown in Table 7. The GTX 480 utilizes a 529 mm2 chip size and publications indicate that the vast majority of this space is spent on shader cores and the cache [Wittenbrink et al. 2011] (i.e. the resources utilized in software implementations of BVH construction). The proposed downsized implementation would not be much larger than the value of 31.88 mm2 shown in Table 7, making it around 10× to 15× smaller. Moreover, the GTX 480 uses a smaller feature size (40 nm) [nVidia, 2010], whereas the estimates are based on 65 nm libraries, so the actual difference should be even larger. The significance of this is that much fewer transistors would be needed to implement the design, consequently consuming still less power.

One possible confounding of this observation may be a difference in the level of switching activity between a GPU and the hardware, and a resulting difference in dynamic power per circuit element. To investigate this, data from the RTL simulations was used to calculate the average activity of each class of FP core and the primitive buffer read and write ports in the design. The activity refers to the proportion of clock cycles in which a unit actually produces a result. For example, one result every two cycles would result in an activity of 50%. In each case, the switching activity was within 20%, a typical value for many circuits. The architecture of the invention is therefore not expected to exhibit unusually high dynamic power.

Finally, a significant observation relates to data access. It is known among chip designers that off-chip data access to DRAM 210 is around two orders of magnitude more expensive than accessing a local buffer 310 in terms of power consumption, and even accessing a cache across the chip can be well over one order of magnitude more expensive [Dally, 2011]. In addition, the power consumption of off-chip memory accesses is known to be more than an order of magnitude more expensive than floating-point operations [Dally, 2009]. Moving data on and off the chip thus constitutes a substantial portion of the total power consumption. Table 4 and the above show that the present architecture generates about half the number of data accesses to external memory 310 than prior art software approaches for the same scene, and this could be reduced further by increasing the size of the primitive buffers 310. Moreover, all of the internal accesses are highly local to the primitive buffers 310, indicating high power efficiency once again.

It is therefore believed that the present architecture offers a much more power-efficient alternative to software algorithms running on many-core processors. The prediction of many in the computer architecture [Esmaeilzadeh et al. 2011; Daily 2011] and graphics communities [Johnsson et al. 2012] is that scaling of future processor designs will be limited by power consumption. The inventors presently argue, as other authors have argued [Chung et al. 2010; Venkatesh et al. 2010], that judicious use of fixed-function may form part of a solution to this problem.

Based on the results and observations, the present architecture is considered a strong contender for this purpose, especially as acceleration data-structure construction is useful in a broad range of applications, including other rendering algorithms and collision detection.

Further details regarding methods, processes, materials, modules, components, steps, embodiments, applications, features, and advantages are set forth in “A Hardware Unit for Fast SAH-Optimised BVH Construction, the entire content of which is incorporated herein in its entirety. All documents that are cited in Exhibit 1 are also incorporated herein by reference in their entirety.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications which are set forth in this specification are approximate, not exact. They are intended to have a reasonable range which is consistent with the functions to which they relate and with what is customary in the art to which they pertain.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A graphics data processing architecture for constructing a hierarchically-ordered acceleration data structure in a rendering process, comprising:
at least two builder modules, consisting of
at least a first builder module configured for building a plurality of upper hierarchical levels of the data structure, connected with
at least a second builder module configured for building a plurality of lower hierarchical levels of the data structure; and
wherein each builder module comprises
at least one memory interface comprising at least a pair of memories;
at least two partitioning units, each connected to one respective of the pairs of memories and configured to read a vector of graphics data primitives therefrom and to partition the primitives into one of two new vectors according to which side of a splitting plane the primitives reside;
at least three binning units connected with each partitioning unit and the memory interface, one binning unit for each of the threes axes X, Y and Z of a three-dimensional graphics scene, and each configured to latch data from the output of the pair of memories and to calculate and output an axis-respective bin location and the primitive from which the location is calculated; and
a plurality of calculating modules connected with the binning units for calculating a computing cost associated with each of a plurality of splits from the splitting plane and for outputting data representative of a lowest cost split.

2. A graphics data processing architecture according to claim 1, wherein each calculating module comprises:
a plurality of buffer-accumulator blocks, one for each binning unit, wherein each block comprises three buffer-accumulators per block, one for each of the threes axes X, Y and Z, and wherein each block is configured to compute a partial vector;
a plurality of merger modules, each respectively connected to the buffer-accumulators associated with a same axis X, Y or Z and wherein each merger unit is configured to merge the output of the blocks into a new vector;
a plurality of evaluator modules, each connected to a respective merger module and wherein each evaluator module is configured to compute the lowest computing cost based on the new vector; and
a module connected to plurality of evaluator modules and configured to compute the global lowest cost split based on the computed lowest computing costs in all three axes X, Y and Z.

3. A graphics data processing architecture according to claim 1, wherein the first builder module is a an upper builder and each memory of the pair thereof comprises a dynamic random access memory (DRAM) module.

4. A graphics data processing architecture according to claim 3, wherein the upper builder is configured to read primitives in bursts and to buffer writes into bursts before they are requested.

5. A graphics data processing architecture according to claim 1, wherein the second builder module is a subtree builder and each memory of the pair thereof comprises a high bandwidth/low latency on-chip internal memory configured as a primary buffer.

6. A graphics data processing architecture according to claim 5, wherein each primary buffer has a die area of 0.94 mm² at 65 nm.

7. A graphics data processing architecture according to claim 5, wherein the subtree builder module has a die area of 31.88 mm² at 65 nm.

8. A graphics data processing architecture according to claim 1, wherein the hierarchically-ordered acceleration data structure is a binary tree comprising hierarchically-ordered nodes, each node representing a bounding volume which bounds a subset of the geometry of the three-dimensional graphics scene to be rendered.

9. A graphics data processing architecture according to claim 8, wherein a data width of the memory interface is sufficiently large for a full primitive of an axis-aligned bounding box (AAB) to be read in each data processing cycle.

10. A graphics data processing architecture according to claim 8, wherein the hierarchically-ordered acceleration data structure comprises binned Surface Area Heuristic bounding volume hierarchies (‘SAH BVH’).
